(19) United States
(12) Patent Application Publication
(10) Pub. No.: US 2021/0097271 A1
(43) Pub. Date: Apr. 1, 2021

(54) CHARACTER RECOGNITION USING PREVIOUS RECOGNITION RESULT OF SIMILAR CHARACTER

(71) Applicant: Hewlett-Packard Development Company, L.P., Spring, TX (US)

(72) Inventors: Yu Na KIM, Seongnam-si (KR); Hyung Soo OHK, Seongnam-si (KR); Dong Hyeop HAN, Seongnam-si (KR)

(21) Appl. No.: 17/050,033

(22) PCT Filed: Nov. 23, 2018
(86) PCT No.: PCT/KR2018/014530

§ 371 Date: Oct. 23, 2020

(30) Foreign Application Priority Data
Jul. 23, 2018 (KR) 10-2018-0085263

(51) Int. Cl. G06K 9/00; G06K 9/62; H04N 1/00; G06K 9/72

(52) U.S. Cl. CPC G06K 9/00442; G06K 9/6215; G06K 2209/01; G06K 9/72; H04N 1/00331

(57) ABSTRACT

An image reading apparatus is provided. The image reading apparatus includes a memory to store a character set including characters of similar shape, a scan device to scan a document, and a processor to generate a scan image corresponding to the scanned document, and perform character recognition of the scan image, wherein the processor recognizes the characters of similar shape by using characteristic information of a character included in a word that succeeds in recognition among words including a character included in the character set.

### BACKGROUND ART

An image reading apparatus is an apparatus for scanning an original image such as a document, a picture, a film, or the like and converting the scanned image into digital data. The digital data may be displayed on a monitor of a computer or printed by a printer and generated as an output image.

An image reading apparatus may support a character recognition function, thus making it is possible to generate scan data capable of extracting text.

### DISCLOSURE OF INVENTION

[symbol]

### BRIEF DESCRIPTION OF DRAWINGS

The above and other aspects, features, and advantages of certain examples of the disclosure will be more apparent from the following description taken in conjunction with the accompanying drawings, in which:

FIG. 1 is a view illustrating a configuration of an image reading apparatus, according to an example;

FIG. 2 is a view illustrating a more detailed configuration of an image reading apparatus, according to an example;

FIG. 3 is a view illustrating a configuration of a scan device, such as the scan device of FIG. 1, according to an example;

FIG. 4 is a view illustrating a pre-registered character set, according to an example;

FIG. 5 is a view to explain shape information, according to an example;

FIG. 6 is a flowchart of a character recognition method, according to an example; and

FIG. 7 is a flowchart of a character recognition method on a page basis, according to an example.

Throughout the drawings, it should be noted that like reference numbers are used to depict the same or similar elements, features, parts, components, and structures.

### MODE FOR THE INVENTION

Hereinafter, various examples will be described with reference to the drawings. The examples described below may be modified and implemented in various different forms. In order to more clearly describe the features of the examples, a detailed description of matters known to those skilled in the art will be omitted.

When the specification states that one constituent element is “connected to” another constituent element, it includes a case in which the two constituent elements are connected to each other with another constituent element intervened therebetween as well as a case in which the two constituent elements are directly connected to each other. Further, when one constituent element “comprises (or includes)” another constituent element, unless specifically stated to the contrary, it includes a case in which other constituent elements may be further included rather than precluding the same.

The expression “image forming job” as used herein may refer to various jobs related with an image, such as, formation of an image or generation/storage/transmission of an image file (e.g., printing, copying, scanning, or faxing), and the expression “job” as used herein may refer to not only the image forming job, but also a series of processes required for performance of the image forming job.

The expression “image forming apparatus” as used herein may refer to an apparatus that scans an image of the document and generates a scanned image. Examples of an image forming apparatus may include a scanner, a copier, a facsimile, or a multi-function printer (MFP) implementing functions of the above. Meanwhile, when the image forming apparatus is a copier, a facsimile, an MFP, or the like, which are capable of the image forming job, the copier, the facsimile, the MFP, or the like may also be referred to as the image forming apparatus.

The expression “content” as used herein may refer to any type of data as a subject of the image forming job, such as a picture, an image, a document file, or the like.

The expression “scan image” as used herein may refer to a scan image in an image reading apparatus such as a black and while image, a color image, etc. or file formats of various forms (e.g., BMP, JPG, TIFF, PDF, etc.)

The expression “main scanning direction” as used herein may refer to a scanning direction of a scanning apparatus, specifically, a direction perpendicular to a movement direction of a document (or a scanning apparatus).

The expression “sub-scanning direction” as used herein may refer to a movement direction of a document (or a scanning apparatus).

The expression “user” as used herein may refer to a person who performs a manipulation related to an image forming job using the image forming apparatus or a device connected to the image forming apparatus by wires or wirelessly. Further, the expression “manager” as used herein may refer to a person who has an authority to access all the functions and systems of the image forming apparatus. The “manager” and the “user” may refer to the same person.

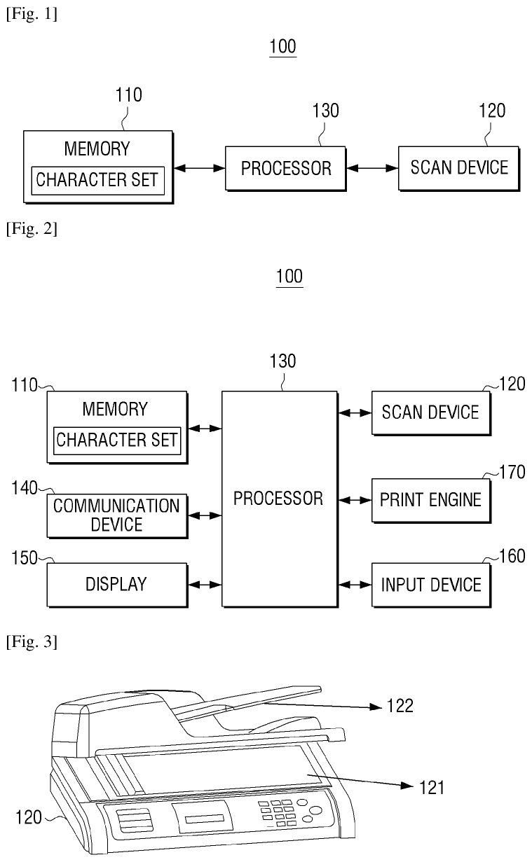

FIG. 1 is a view illustrating a configuration of an image reading apparatus, according to an example.

Referring to FIG. 1, an image reading apparatus 100 may include a memory 110, a scan device 120, and a processor 130.

The memory 110 may store scan data scanned by the image reading apparatus 100. The memory 110 may store a scan image generated by the processor 130, which will be described below, a character recognition result, a word recognition result, or the like.

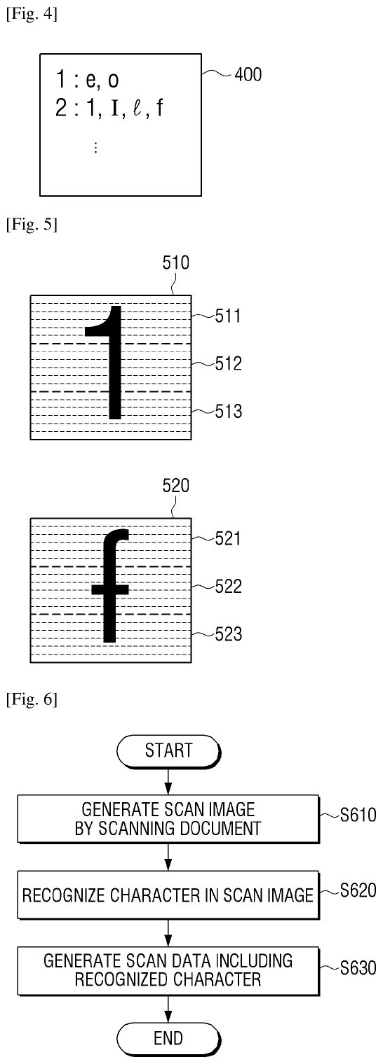

The memory 110 may store character sets including characters of similar shape. A character set may be a group of characters of similar shape, for example, e, o, or 1, I, l, f, etc. as shown in FIG. 4. Characters of similar shape may be likely to be recognized as being different from actual characters according to font, scan resolution of printed material, etc. For example, “e” may have a shape of “θ” depending on a scan environment, and in this case, “e” may be recognized as “o” rather than “e”.

According to examples of the present disclosure, similar types of characters having a high possibility of misrecognition, that is, a character set may be stored, and characters included in the character set may be recognized by using characteristic information of the characters.

Such a character set may be initially provided by a manufacturer of the image reading apparatus 100, or set by a user.

A character may be a minimum unit for a word, and may be a letter of an alphabet, Hangul, a Chinese character, etc., or may be referred to as a letter.

The memory 110 may store characteristic information of characters included in a character set. The characteristic information may be reset in a unit of a document page. a scan job, or the like.

The characteristic information of a character may be shape information of the character. For example, shape information of the character may include edge direction information, dot count information, transition count information, height information, etc. in an image area including a character. The meaning and extraction method of each information will be described with reference to FIG. 5.

The memory 110 may include dictionary information. The dictionary information may include information of words in the dictionary.

The memory 110 may be embodied as a storage medium in the image reading apparatus 100 or an external storage medium such as a removable disk including a universal serial bus (USB) memory, a storage medium connected to a host, a web server through a network, or the like.

The scan device 120 may scan a document. For example, the scan device 120 may irradiate light onto the document, and read image information of the document from reflected light. The scan device 120 may be embodied in the form of a flatbed and/or an automatic document feeder (ADF).

The processor 130 may control each constituent element of the image reading apparatus 100. For example, the processor 130 may be embodied as a central processing unit (CPU), an application specific integrated circuit (ASIC), etc. The processor 130 may, based on a scan command being input from a user, control the scan device 120 to scan a document.

The processor 130 may generate a scan image based on data provided by the scan device 120. The processor 130 may perform various image processing operations with respect to the initially scanned image. For example, the image processing may be a skew correction, a color correction, or the like.

The processor 130 may recognize a character included in the scan image, and generate a content having a character recognition result. The content may be a scan image which can extract the character recognition result as text, or a text file or text information including only the character recognition result.

The processor 130 may binarize a scan image, divide the binarized scan image into a plurality of areas, and perform a character recognition operation on an area including text.

When a character included in a character set is identified in the character recognition operation, the processor 130 may perform recognition of the character included in the character set based on characteristic information of a character with successful word recognition among words including the character.

The processor 130 may extract at least one candidate character for each character in a scan image. The processor 130 may divide a scan image on a character basis, and extract at least one candidate character having a confidence value greater than a predetermined threshold value for each divided image area. In an example, the processor 130 may recognize a candidate character having a highest confidence value in the area as a character for the area.

The processor 130 may recognize a word by using at least one candidate character (or a recognized character) extracted from each character forming a word and dictionary information. When a combination of candidate characters extracted from respective characters forming a word matches with a word in the dictionary information, the processor 130 may recognize the combination of the candidate characters as a word for the image area.

When a character included in a character set is included in the extracted candidate character, the processor 130 may extract characteristic information on the character, and when recognition of the word is successful, store the characteristic information of the character and the recognition result corresponding to the characteristic information in the memory 110.

When recognition of the word including the character included in the character set fails, the processor 130 may compare the characteristic information on the character with the character information of the character stored in the memory 110 and perform an additional recognition process for the character.

For example, if the words “envy” and “eye” exist in a document, the character “e” may have the form of “θ” for reasons such as font uniqueness, blur of the print material, a low resolution, or the like. In this case, in the character recognition process, the words “envy” and “eye” may be recognized as “θnvy” and “θyθ”, and the “o” and the “e” may be extracted as a candidate character with respect to “θ”.

Accordingly, in the word recognition process, “θnvy” may be recognized as “envy” or “onvy”, and “θyθ” may be recognized as “eye”, “oyo”, “oye”, or “eyo”. In this case, the processor 130 may recognize “θnvy” as “envy” based on the word in the dictionary. However, all of “eye”, “oyo”, and “oye” may be present in the dictionary, and thus it is difficult to recognize a correct word with only dictionary information with respect to “θyθ”.

However, since the same character repeatedly exists in one document, and the type of character is the same, the processor 130 may store the characteristic information of “θ” and the recognition result of “e” in the memory 110 with respect to “θnvy” that succeeds in word recognition.

Accordingly, in the word recognition process of “θyθ”, the processor 130 may extract characteristic information on “θ”, compare the characteristic information with the characteristic information of “θ” stored in the memory 110, and recognize “θ” of the word “θyθ” as “e”.

Since a character shape is changed in a unit of a document, a scan job, or the like, the processor 130 may reset the characteristic information stored in the memory 110 in a unit of a document page, a scan job, or the like.

An example configuration of the image reading apparatus 100 has been illustrated and described, but in other examples, various configurations could be further added.

FIG. 2 is a view illustrating a more detailed configuration of an image reading apparatus, according to an example.

Referring to FIG. 2, an image reading apparatus 100 may include a memory 110, a scan device 120, a processor 130, a communication device 140, a display 150, an input device 160, and a print engine 170.

The memory 110 and the scan device 120 have been described with reference to FIG. 1, and a redundant description will be omitted. The processor 130 has also been described with respect to FIG. 1. Thus, the description made in FIG. 1 will be omitted to avoid redundancy, but the additional configuration in FIG. 2 will be described below.

The communication device 140 may be formed for connecting the image reading apparatus 100 to an external apparatus (not shown). In various examples, the communication device 140 may not only connect the image reading apparatus 100 to an external apparatus such as a terminal apparatus, through a local area network (LAN) or an Internet network, but also through a USB port or a wireless communication (for example, WiFi 802.11a/b/g/n, near field communication (NFC), Bluetooth, etc.) port. To this end, the communication device 140 may include a communication module (e.g., a transceiver) supporting at least one of various wired and wireless communication methods.

The communication device 140 may transmit a scan image generated by the scan device 120, scan data, content, etc. to an external device (not shown).

The communication device 140 may receive dictionary information and/or information on a character set from an external device (not shown). When the dictionary information and/or the character set is received from the external device (not shown), the processor 130 may update the dictionary information and/or the character set stored in the memory 110.

The display 150 may display various information provided by the image reading apparatus 110. The display 150 may display a user interface window for selecting various functions provided by the image reading apparatus 100. A user may input a scan command on the displayed user interface window. The scan command may be a command for performing only a scan operation, or may be a command for transmitting a scanned job to a specific server such as a scan-to-server, a scan-to-DLNA, a scan-to-cloud, etc.

In addition, when the image reading apparatus 100 is an MFP capable of a printing job, a copying job, or the like, a scan command may be a copy command using a scan function. According to an example, only a case of receiving a scan command through the input device 160 has been described. However, in other examples, a scan command may be received from a host device (not shown) through the communication device 140.

The display 150 may display the generated scan image and information on the generated scan image. The displayed scan image may be a scan image itself, or a preview image of the scan image.

The input device 160 may receive a command for selecting or controlling a function from a user. The function may be a print function, a copy function, a scan function, a fax transmission function, or the like. The input device 160 may receive a command through a control menu displayed on the display 150.

The input device 160 may receive a character recognition function for the scan image. The input device 160 may receive a function of selecting a file format of a content to be generated. The input device 160 may include an apparatus that may receive various types of user input, such as a keyboard, a physical button, a touchscreen, a camera, a microphone, etc.

The print engine 170 may print printing data. The print engine 170 may form an image on a recording medium by various printing methods such as an electrophotographic method, an inkjet method, a thermal transfer method, a direct thermal method, and the like. For example, the print engine 170 may print an image on a recording medium by a series of processes including exposure, development, transfer, fixation, and the like.

Based on a scan command being received from the communication device 140 or the input device 160, the processor 130 may control the scan device 120 to scan a document.

When a scan operation is performed under the control of the scan device 120, the processor 130 may generate a scan image based on data output from the scan device 120. When receiving a command for a character recognition function from a user, the processor 130 may perform a character recognition function on the generated scan image.

The processor 130 may generate content corresponding to a file type set by a user through the input device 160. For example, when a user selects a pdf file with the character recognition function as an output file, the processor 130 may generate pdf content by using the character recognition result and the generated scan image.

The processor 130 may control the communication device 140 to transmit the pre-registered storage for the user.

When a user inputs a copy command, the processor 130 may control the print engine 170 to print the generated scan image.

As described above, the image reading apparatus 100 performs recognition of characters of similar shape by using characteristic information of a word that succeeds in word recognition. Thus, a recognition rate is increased even for a character which is difficult to recognize, such as proper noun.

FIG. 3 is a view illustrating a configuration of a scan device, such as the scan device of FIG. 1, according to an example.

Referring to FIG. 3, a scan device 120 may include a first scan device 121 in the form of a flatbed for scanning a document placed on a platen, and a second scan device 122 in the form of an automatic paper feeder capable of continuously scanning documents placed on an automatic feeder.

The first scan device 121 may be a scan device in the form of a flatbed. A document may be placed on a platen, and a scan module may move under the platen on which the document is placed to scan the document.

The processor 130 may reset characteristic information extracted on a document page basis during a scan operation and a character recognition process using the first scan device 121.

The second scan device 122 may be a scan device in the form of an automatic paper feeder. One or more pieces of paper (i.e., a document) may be placed on a paper feeder, and sequentially moved to a paper movement path. A scan module disposed on the paper movement path may scan the document. The second scan device 122 may be a single-sided scan device which scans only a single-side of a document, or a double-sided scan device which scans two sides of a document.

The processor 130 may reset characteristic information extracted on a scan job basis during a scan operation and a character recognition process by using the second device 122. In other words, a plurality of characters in a document read by a single scan operation may have a similar shape and thus, the processor 130 may reset characteristic information extracted on a scan job basis.

In the illustration and description of FIGS. 1 to 3, it is described that a document recognition operation is performed by an image reading apparatus. However, the above-described character recognition may be embodied by an electronic device such as a personal computer (PC) which does not have a scan device.

FIG. 4 is a view illustrating a pre-registered character set, according to an example.

Referring to FIG. 4, two character sets 400 of similar shape are illustrated. Although

FIG. 4 illustrates only the two character sets 400, in other examples, three or more of character sets may be pre-stored in the image reading apparatus 100.

A first character set may include e and o, and a second character set may include 1, I, l and f.

A character included in a character set may be easily recognized as another character in the character set during the character recognition process.

For example, e may have a shape such as “θ” in the scan image, and a shape such as “θ” may be recognized as the letter “o” or the letter “e” during the character recognition process in some cases.

Conventionally, words/characters may be recognized based on a combination of candidate characters included in each word and words in the dictionary.

The character recognition for a word in the dictionary may be most likely recognized, but the character recognition for a word which is not in the dictionary, such as a proper noun, a neologism, and the like, is less recognized.

It is typical that one character has the same shape in one page or in one scan job. Therefore, according to an example, a recognition rate can be increased by recognizing characters of similar shape by using a character shape of a word that succeeds in word recognition, among words including a character included in a character set.

According to an example, characteristic information on a character is extracted in order to recognize a character shape. Hereinafter, examples of the extracted characteristic information will be described with respect to FIG. 5.

FIG. 5 is a view to explain shape information, according to an example.

Referring to FIG. 5, the number “1” and the letter “f” included in the second character set of FIG. 4 are illustrated.

In order to distinguish the two characters (i.e., the number “1” and the letter “f”), characteristic information of each character may be extracted. The characteristic information may be edge direction information, dot count information, transition count information, height information, and the like in the image area.

The edge direction information may be information on the number of edge directions in an image area including a character. When an image area is divided into a plurality of areas, the edge direction information may include edge direction information of each divided area.

For example, edge direction information on a first image 510 may include information that one diagonal edge is included in a left bottom direction in an upper area 511, one vertical edge is included in a middle area 512, and one vertical edge is included in a bottom area 513.

Edge direction information on a second image 520 may include information that one diagonal edge is included in a right upper direction in an upper area 521, one horizontal edge and one vertical edge are included in a middle area 522, and one vertical edge is included in a lower area 523.

The dot count information may be information on the number of black dots in a main scanning direction (e.g., column by column, line by line, etc.) in an image area. For example, dot count information on the first image 510 may include information that the first column is zero (0), the second column is two (2), the third column is three (3), the fourth column is five (5), . . . , and so on. In an example, the above-described dot count information may be used as a sum of values of all columns or a sum of values of three divided area. In addition, it is also possible to use the number of black dots in a sub-scan direction (e.g., row by row) in the image area.

The transition count information may be information on the number of transitions of the dots in the main scanning direction (e.g., row by column, line by line, etc.) in the image area (i.e., a change from a black dot to a white dot or a white dot to a black dot). For example, the transition count information on the first image 510 may include information that the first column is zero (0), the second column is two (2), the third column is two (2), the fourth column is two (2), . . . , and so on. In an example, the above-described transition count information may be used as a sum of values of all rows or a sum of values of three divided areas.

The height information may be relative height information between peripheral characters and the corresponding character.

In an example, the image forming apparatus 100 may use one of the above-described information as characteristic information, or each of four types of information, or may use a value calculated by giving a weight on four types of information as character information.

FIG. 6 is a flowchart of a character recognition method, according to an example.

Referring to FIG. 6, a document may be scanned and a scan image may be generated at operation S610. For example, a document loaded in the scan device 120 may be scanned and a scan image may be generated based on data output from the scan device 120. An image processing operation such as skew correction, color correction, etc. may be additionally performed on the generated scan image.

Character recognition of the generated scan image may be performed by using a prestored character set including characters of similar shape at operation S620. Characters included in a character set may be recognized by using characteristic information on characters included in a word successfully recognized among words including the characters included in the character set. An example of a character recognition operation has been described with respect to FIG. 1. Therefore, repetition will be omitted.

Scan data may be generated by using a character recognition result and a scan image at operation 630. For example, content set by a user or content corresponding to a preset file format may be generated by using the character recognition result and the generated scan image.

According to an example, character recognition is performed by using characteristic information of a word that succeeds in word recognition with respect to characters of similar shape, and therefore, a recognition rate of a character which cannot be easily recognized, such as a proper noun, may be increased.

An example character recognition method as described above may be embodied as at least one execution program for executing the image reading method as described above, and such execution program may be stored in a computer readable recording medium.

Each block may be embodied as a computer recordable code on a computer readable recording medium. The computer readable recording medium may be a device that stores data readable by a computer system.

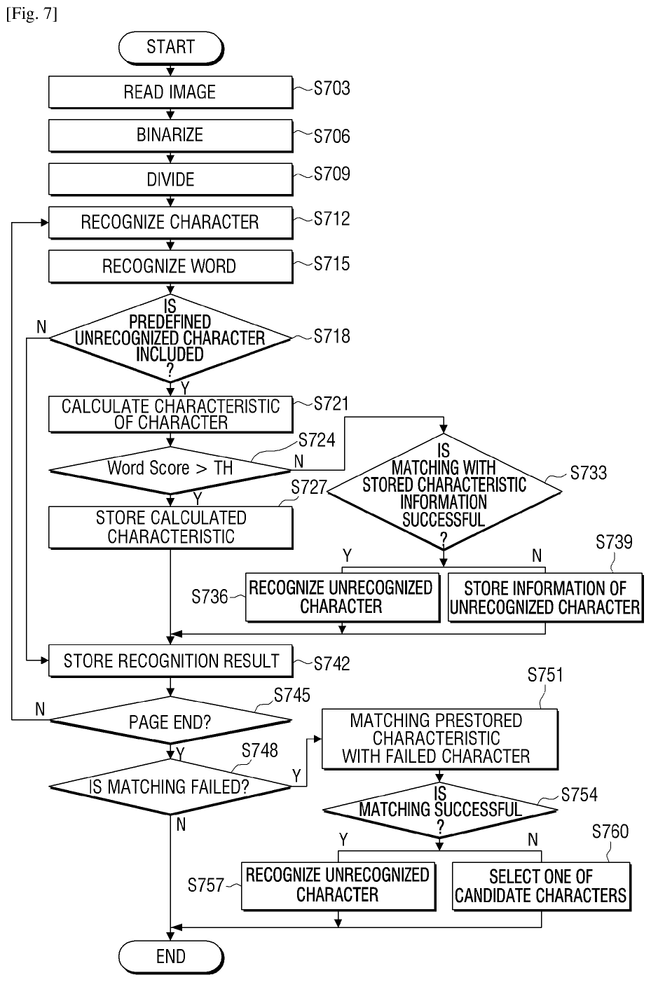

FIG. 7 is a flowchart of a character recognition method on a page basis, according to an example.

Referring to FIG. 7, a scan image may be read at operation S703, and the read scan image may be binarized at operation S706.

The binarized scan image may be divided on a character basis at operation S709, and character recognition may be performed in a unit of the divided area at operation S712. A character having a highest confidence value by the divided image area may be recognized as a character for the corresponding image. Candidate characters having a confidence value greater than a preset threshold value by the divided image area may be selected, and upon the result of determination, one of the candidate characters may be recognized as a character for the area. Hereinafter, an example of recognizing a character having a highest confidence value for each image area will be described.

Word recognition may be performed by using a combination of the recognized characters at operation S715. Word recognition may be performed by combining a plurality of characters in a main scanning direction. If texts are arranged in a vertical direction, word recognition may be performed by combining a plurality of characters in a sub-scanning direction.

During the process of word recognition, it can be determined whether a pre-defined unrecognized character, that is, a character included in a character set is included at operation S718.

When it is determined that the word does not have the character included in the character set at operation S718-N, the previously recognized word may be stored at operation S742, and recognition of the next character and word may be repeatedly performed.

When it is determined that the word includes the character included in the character set at operation S718-Y, an additional word recognition process may be performed. For example, characteristic information on the character included in the character set may be extracted at operation S721. A method for extracting the characteristic information has been described with respect to FIG. 5. Therefore, the repetition thereof will be omitted.

It can be determined whether a combination of the recognized characters is in the dictionary at operation S724. For example, it is possible to calculate the probability that a word corresponding to a combination of recognized characters matches a word in the dictionary and determine whether the calculated probability exceeds a preset threshold value.

If the combination of the recognized characters is in the dictionary at operation S724-Y, it is determined that the word is successfully recognized (i.e., a recognition result at operation S715 is confirmed), and the previously recognized character and the characteristic information of the character may be stored in the memory 110 at operation S727.

If the combination of the recognized characters is not in the dictionary at operation S724-N, it is determined that the word is not successfully recognized (i.e., a recognition result at operation S715 is not confirmed), and matching of the characteristic information stored in the memory 110 and the newly extracted characteristic information may be performed at operation S733.

When the same characteristic information is stored in the memory 110 during the matching process, that is, when the matching is successful at operation S733-Y, the character in the word which fails in word recognition may be recognized as a character corresponding to the matched characteristic information at operation S736.

However, when the matching fails at operation S733-N, that is, when the same characteristic information is not stored in the memory 110, recognition of the character and word may be stopped, and the information corresponding thereto may be stored in the memory 110 at operation S739.

When the above process is performed on an entire area of a document, and a character recognition process on the entire area of the document is once completed at operation S745-Y, it can be determined whether there is a history in which recognition of the character and word is stopped at operation S748.

As a result, when there is a history in which the matching is failed at operation S748-Y, matching of the characteristic information of the character and the characteristic information stored in the memory 110 may be performed at operation S751.

When the same characteristic information is stored in the memory 110 during the matching due to the above-process, when the matching is successful at operation S754-Y, the character in the word that fails in word recognition may be recognized as the character corresponding to the matched characteristic information at operation S757.

However, when the matching is failed at operation S754-N, the recognition result at operation S712 may be confirmed. When candidate characters having a confidence value greater than a preset threshold value are selected by each divided image area at operation S712, a candidate character having a greatest confidence value among candidate characters may be recognized as the character at operation S760. In an example, a candidate character may be displayed by a user, and one of the candidate characters may be selected by a user.

Referring to FIG. 7, it is described that words and characters in a scan image are sequentially recognized. However, in another example, character recognition and word recognition may be performed with respect to all characters, and only words including characters included in a character set or characters may be embodied in such a manner that the algorithm as described above is used for verification.

The above-described examples may be embodied in the form of a non-transitory computer-readable recording media for storing computer-executable instructions and data. At least one of the instructions and data may be stored in the form of a program code and, when executed by a processor, generate a predetermined program module and thereby perform a predetermined operation.

The non-transitory computer-readable recording media may include, for example, a magnetic storage media like a hard disk, etc., optical recording media selected from CD, DVD, etc., or a memory included in a server that may be accessed via a network. For example, the computer-readable recording media may be at least one of the memory 140 included in the image forming apparatus 100 and a memory (not shown) included in the input/output unit 110. Alternatively, the computer-readable recording media may be the memory 240 included in the external apparatus 200 connected to the image forming apparatus 100 via a network.

Although examples have been shown and described, it will be appreciated by those skilled in the art that changes may be made to these examples without departing from the principles and spirit of the present disclosure. Accordingly, the scope of the present invention is not construed as being limited to the described examples, but is defined by the appended claims as well as equivalents thereto.

1. An image reading apparatus, comprising:
a memory to store a character set including characters of similar shape;
a scan device to scan a document; and
a processor to:
generate a scan image corresponding to the scanned document, and perform character recognition of the scan image,
wherein the processor recognizes the characters of similar shape by using characteristic information of a character included in a word that succeeds in recognition among words including a character included in the character set.

2. The image reading apparatus as claimed in claim 1, wherein the processor, based on the character included in the character set being detected, extracts characteristic information of the detected character, compares the extracted character information with the characteristic information of the character included in the word, and recognizes the detected character.

3. The image reading apparatus as claimed in claim 1, wherein the processor, based on the character included in the character set being detected, extracts characteristic information of the detected character, and based on the word including the character being successfully recognized, stores the extracted characteristic information and a recognition result corresponding to the characteristic information in the memory.

4. The image reading apparatus as claimed in claim 3, wherein the processor, based on recognition of the word including the character being failed, compares the extracted characteristic information with the characteristic information stored in the memory, and recognizes the character included in the word that fails in the word recognition.

5. The image reading apparatus as claimed in claim 3, wherein the processor resets the characteristic information of a character stored in the memory in a unit of a scan image or a scan job.

6. The image reading apparatus as claimed in claim 1, wherein the characteristic information is at least one of edge direction information, dot count information, transition count information, or height information in an image area including the character.

7. The image reading apparatus as claimed in claim 1, wherein the processor extracts at least one candidate character with respect to each character in the scan image, recognizes a word by using at least one extracted candidate character of each character included in a word on a word basis, and based on the character included in the character set being included in the extracted candidate character, performs character recognition by using the character information of the character included in the word that succeeds in the recognition.

8. The image reading apparatus as claimed in claim 1, wherein the processor generates scan data by using a result of the character recognition and the scan image.

9. A method for character recognition, the method comprising:
generating a scan image;
performing character recognition of the generated scan image by using a pre-stored character set including characters of similar shape; and
generating scan data by using a result of the character recognition and the scan image,
wherein the performing of the character recognition comprises recognizing the characters of similar shape by using characteristic information of a character included in a word that succeeds in recognition among words including a character included in the character set.

10. The method as claimed in claim 9, wherein the performing of the character recognition comprises:
based on the character included in the character set being detected, extracting characteristic information of the detected character; and
comparing the extracted characteristic information with the characteristic information of the character included in the word that succeeds in the recognition, and recognizing the detected character.

11. The method as claimed in claim 9, wherein the performing of the character recognition comprises:
based on the character included in the character set being detected, extracting characteristic information of the detected character;
performing word recognition of a word including the character; and
based on the word recognition being successful, storing the result of the character recognition of a result of the word recognition and the characteristic information of the character.

12. The method as claimed in claim 11, wherein the performing of the character recognition comprises, based on the word recognition being failed, comparing the stored characteristic information with the characteristic information of the character included in the word that fails in the word recognition, and recognizing the character of the word that fails in the word recognition.

13. The method as claimed in claim 11, further comprising:
resetting the stored characteristic information of a character in a unit of a scan image or a scan job.

14. The method as claimed in claim 9, wherein the characteristic information is at least one of edge direction information, dot count information, transition count information or height information in an image area including the character.

15. The method as claimed in claim 9, wherein the performing of the character recognition comprises extracting at least one candidate character with respect to each character in the scan image, recognizing a word by using at least one extracted candidate character of each character included in a word on a word basis, and based on the character included in the character set being included in the extracted candidate character, performing character recognition by using the characteristic information of the character included in the word that succeeds in the recognition.
